(19) United States
(12) Patent Application Publication
(10) Pub. No.: US 2009/0287654 A1
(43) Pub. Date: Nov. 19, 2009

(54) Device for identifying electronic file based on assigned identifier

(76) Inventors: Yoshinori Sato, Machida (JP); Akihiko Kawasaki, Yamato (JP); Satoshi Kai, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/379,716

(22) Filed: Feb. 27, 2009

(30) Foreign Application Priority Data
May 19, 2008 (JP) 2008-130588

(51) Int. Cl. G06F 17/30

(52) U.S. Cl. 707/3; 726/26; 707/100; 707/E17.005; 707/E17.061

(57) ABSTRACT

To trace electronic files held in system users in the organization by recognizing electronic files being communicated in an organization. Provided is an information identification device for assigning an identifier to an electronic file based on data stored in the electronic file. The information identification device includes an interface coupled to a network; a processor coupled to the interface; and a memory coupled to the processor. The information identification device calculates a frequency of appearance of a word in text data included in the electronic file; determines an identifier capable of uniquely identifying the electronic file based on the calculated frequency of appearance; and assigns the determined identifier to the electronic file.

### INCORPORATION BY REFERENCE

This application claims priority based on a Japanese patent application, No. 2008-130588 filed on May 19, 2008, the entire contents of which are incorporated herein by reference.

### BACKGROUND

This invention relates to an information identification device, and more particularly, to an information identification device for tracing electronic data containing text information.

Presently, there poses a problem of leakage of electronic data from organizations due to a loss of media storing electronic data and wrong transmission of electronic mails. As an information security technology for preventing or restraining information from leaking, information security employing access control, encryption, and the like has been practically used. However, this technology does not consider authorized users of electronic data in an organization as subjects of dishonest actions or mistakes for information leakage, and is therefore insufficient as measures against information leakage from inside the organization. For example, when access control is provided for electronic data storing confidential information, an accident may occur that a user holding a valid access permission transmits the electronic data to outside via an electronic mail.

To solve this problem, there has recently been proposed measures against information leakage that, by monitoring electronic files created and being communicated in an organization to thereby recognize who are handling which electronic files in the organization, when an electronic file containing confidential information is being transmitted to the outside of the organization, the transmission is blocked.

As measures against this type of information leakage, there is provided data leakage prevention (DLP). The DLP monitors electronic files created and communicated by information devices such as personal computers, and, when an electronic file to be transmitted to outside of an organization coincides with confidential information registered in advance, controls the transmission by blocking the transmission or issuing a warning.

In order to realize the DLP, a technology for detecting an electronic file coincident with confidential information is disclosed in WO 2006/122086 A2. The above-mentioned technology extracts words from a text included in an electronic file containing confidential information, determines, based on an appearance frequency and a distribution of the extracted words, a set of words for identifying the electronic file, and sets the set of the determined words as a fingerprint. The fingerprint is calculated for respective electronic files containing confidential information (confidential information-contained electronic files), and is registered in association with the confidential information. A fingerprint is also calculated for an electronic file to be transmitted to the outside of the organization (transmitted electronic file), and determines, based on the calculated fingerprint, whether the transmitted electronic file coincides with the confidential information-contained electronic file or not.

As a technology employed for determining whether an electronic file coincides or not, there is known a technology of associative document retrieval. As the associative document retrieval technology, for example, the vector space model and the term frequency and inverse document frequency (TF-IDF). The vector space model produces a query vector from a word set contained in a document which serves as a search key, and produces a document vector from a document to be searched. Then, documents having a document vector similar to the query vector are presented as a result of the search. The search key is a word set which is explicitly given by a searcher and is extracted from known documents.

The TF-IDF is a method of determining significance of a term t constituting a vector. The general TF-IDF uses a frequency of appearance of the term t (term frequency: TF) in a document used as a search key and an inverse of the frequency of appearance of a document which contains the term t and is retrieved (inverse document frequency: IDF), thereby calculating a product of TF and IDF, which is the significance of the term t. JP 3573688 B discloses an associative document retrieval device as the TF-IDF and an improved TF-IDF.

### SUMMARY OF THE INVENTION

According to WO 2006/122086 A2, characteristic term sets are determined respectively from a transmitted electronic file and confidential information-contained electronic files, and fingerprints are calculated based only on values corresponding to the TF of the TF-IDF. Thus, a term set appearing any of the confidential information-contained electronic files may be used for calculating the fingerprint. As a result, the same fingerprint may match a plurality of confidential information-contained electronic files. As a result, even when the technology disclosed in WO 2006/122086 is used in order to monitor usage of electronic files in an organization, there poses a problem that an electronic file may not be correctly traced. Similarly, when the transmission of electronic files is controlled, an electronic file which does not actually match may be blocked by mistake.

The associative document retrieval technology according to JP 3573688 B, terms having the respectively large TF and IDF are used for comparison. When the technology according to JP 3573688 B is employed for tracing an electronic file, it is preferable to use a term set which uniquely identifies the electronic file, namely a term the IDF of 1, but a term having the large TF and the IDF equal to or more than 2 may be used for the comparison. Thus, the technology according to JP 3573688 B has the same problem as in the case of WO 2006/122086. This problem still remains when the TF is a constant common to all the documents. The IDF according to JP 3573688 B is calculated for respective terms, and, when different electronic files storing a similar text exist in a subject of retrieval, and even when the TF is a constant, a term having the IDF equal to or more than 2 may be selected for comparison.

Therefore this invention provides a technology for surely recognizing electronic files being communicated in an organization, thereby tracing electronic files held by system users in the organization.

The invention also provides a technology for, in an electronic mail server, preventing confidential information from leaking via electronic mails by comparing an identifier of an electronic file attached to a transmitted mail to registered electronic files storing confidential information.

A representative aspect of this invention is as follows. That is, there is provided an information identification device for assigning an identifier to an electronic file based on data stored in the electronic file. The information identification device includes an interface coupled to a network; a processor coupled to the interface; and a memory coupled to the processor. The information identification device calculates a frequency of appearance of a word in text data included in the electronic file; determines an identifier capable of uniquely identifying the electronic file based on the calculated frequency of appearance; and assigns the determined identifier to the electronic file.

According to the aspect of this invention, it is possible to assign an identifier for uniquely identifying an electronic file using text data contained in the electronic file.

These and other benefits are described throughout the present specification. A further understanding of the nature and advantages of the invention may be realized by reference to the remaining portions of the specification and the attached drawings.

### BRIEF DESCRIPTION OF THE DRAWINGS

The present invention can be appreciated by the description which follows in conjunction with the following figures, wherein:

FIG. 1 is a block diagram illustrating a configuration of a system in accordance with a first embodiment of this invention;

FIG. 2 is a block diagram illustrating a hardware configuration of a content identifier assigning server in accordance with the first embodiment of this invention;

FIG. 3A is an explanatory diagram illustrating an index information table in accordance with the first embodiment of this invention;

FIG. 3B is an explanatory diagram illustrating a DF storage table in accordance with the first embodiment of this invention;

FIG. 3C is an explanatory diagram illustrating an example of an electronic file in accordance with the first embodiment of this invention;

FIG. 4 is an explanatory diagram illustrating a document usage trail table in accordance with the first embodiment of this invention;

FIG. 5 is an explanatory diagram illustrating a content identifier table in accordance with the first embodiment of this invention;

FIG. 6 is an explanatory diagram illustrating data output from a trail analysis unit in accordance with the first embodiment of this invention;

FIG. 7 is an explanatory diagram illustrating a processing sequence in accordance with the first embodiment of this invention;

FIG. 8 is a flowchart illustrating a processing for creating a content identifier in accordance with the first embodiment of this invention;

FIG. 9 is a flowchart illustrating the processing for updating content identifiers in accordance with the first embodiment of this invention;

FIG. 10 is a block diagram illustrating a configuration of the system in accordance with a second embodiment of this invention; and

FIG. 11 is an explanatory diagram illustrating a processing sequence in accordance with the second embodiment of this invention.

### DETAILED DESCRIPTION OF THE EMBODIMENTS

Referring to the drawings, a description will now be given of embodiments of this invention.

According to the embodiments, a description will be given of an example in which an electronic file held by a system user is traced in a system in which a large number of client computer's are coupled to a network. An identity of a plurality of electronic files is determined based on tokens (words) contained in text data of the electronic files. On this occasion, a set of tokens used for identifying electronic files is referred to as a content identifier. One content identifier is constructed of at least one token.

### First Embodiment

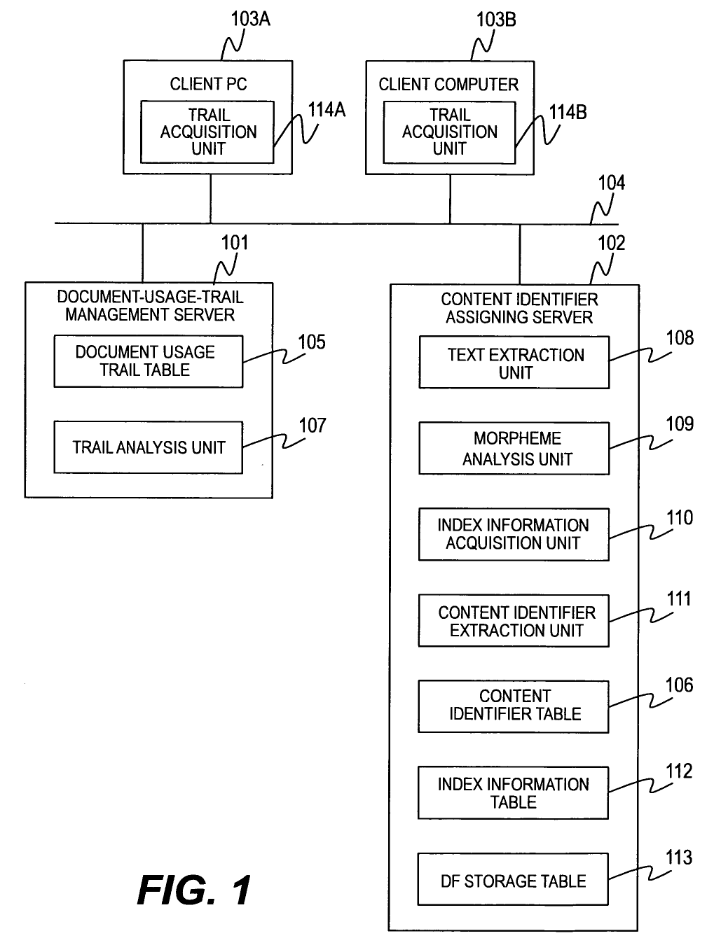

Referring to FIG. 1, a description will be given of a configuration of a system according to a first embodiment of this invention.

FIG. 1 is a block diagram of the configuration of the system according to the first embodiment of this invention. The system illustrated in FIG. 1 includes a document-usage-trail management server 101, a content identifier assigning server 102, and client computer's 103A and 103B.

In the following description, the client computer's 103A and 103B may be collectively referred to as client computer 103. Moreover, trail acquisition units 114A and 114B may be collectively referred to as trail acquisition unit 114. It should be noted that the client computer 103A and the client computer 103B are constructed of the same hardware.

The document-usage-trail management server 101, the content identifier assigning server 102, and the client computer's 103A and 103B are respectively coupled to a communication network 104.

The document-usage-trail management server 101, the content identifier assigning server 102, and the client computer 103 may be realized by any computer such as a personal computer, a server device, and a workstation, for example.

The communication network 104 may be realized by any network to be operated for users in a certain organization such as a local area network (LAN) and a virtual private network (VPN) constructed over the Internet.

The document-usage-trail management server 101 includes a document usage trail table 105 and a trail analysis unit 107.

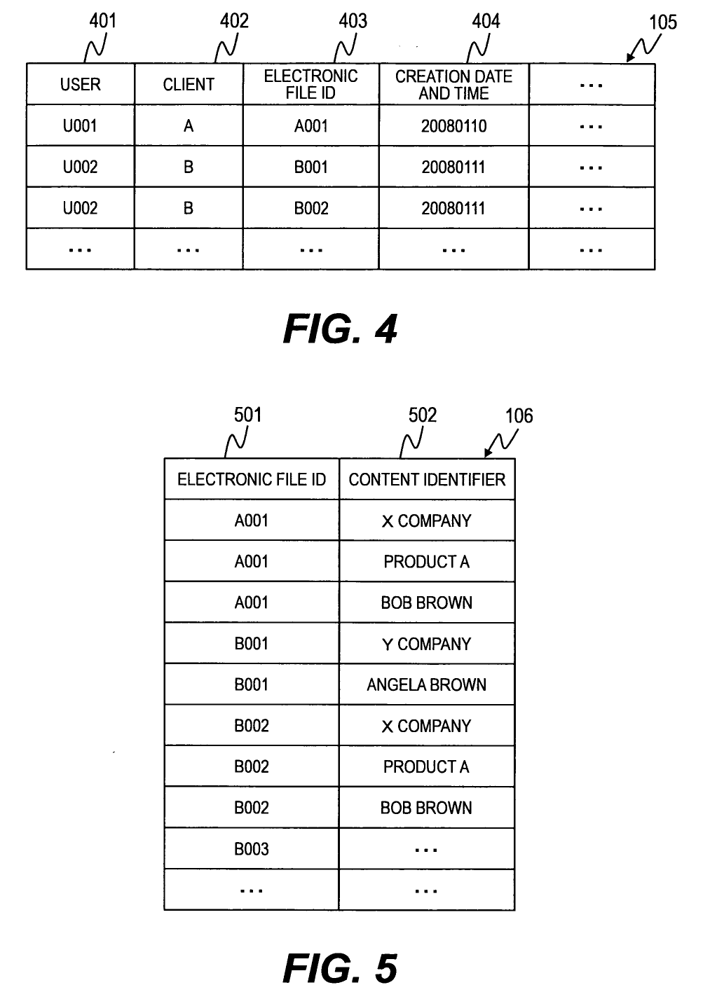

The document usage trail table 105 is stored in a storage 202 described later, and manages trails (history) of usage of electronic files. The document usage trail table 105 will be described later referring to FIG. 4.

The trail analysis unit 107 analyzes data stored in a content identifier table 106, discriminates a user which has owned a specific electronic file, and outputs a result thereof from an output device 205 of the document-usage-trail management server 101.

The trail analysis unit 107 is realized by executing a program (not shown) read from a memory 203 by a CPU 201, which is described later.

The content identifier assigning server 102 includes a text extraction unit 108, a morpheme analysis unit 109, an index information acquisition unit 110, a content identifier extraction unit 111, an index information table 112, a DF storage table 113, and the content identifier table 106.

The text extraction unit 108 extracts text data from an electronic file received via a network interface 206 described later. When the received electronic file includes image data, sound data, and text data, the image data and sound data are removed from the received electronic file, and only the text data is extracted.

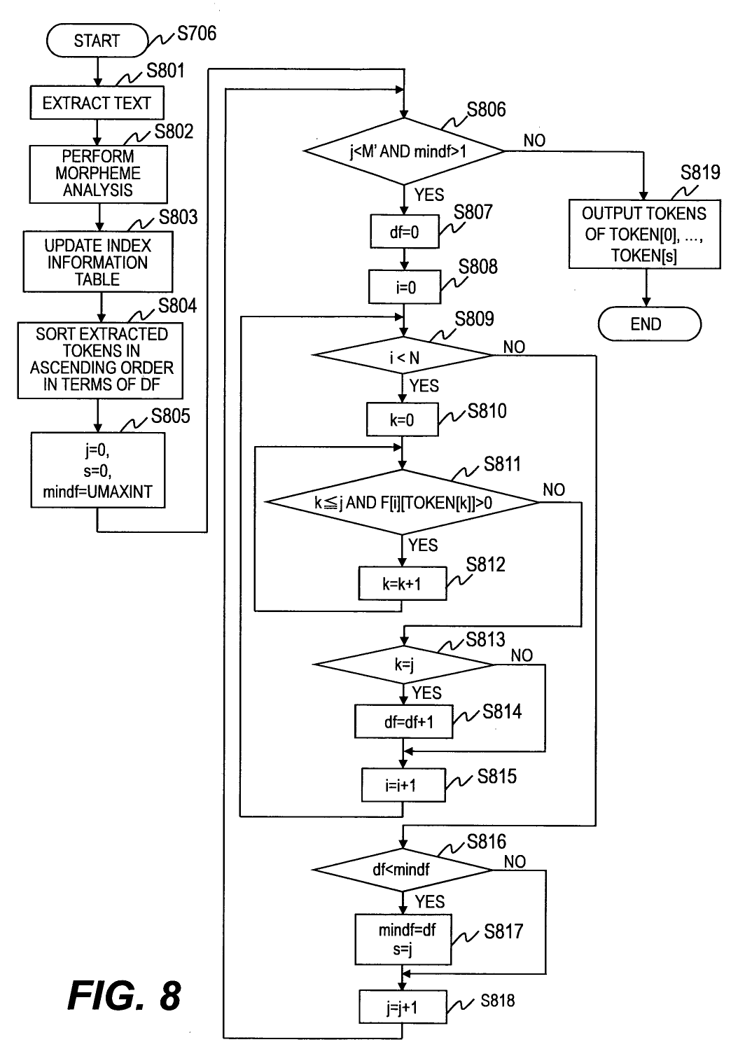

The morpheme analysis unit 109 applies morpheme analysis to the text data extracted by the text extraction unit 108, and extracts tokens (words) appearing in the text data. The morpheme analysis will be described later referring to FIG. 8.

The index information acquisition unit 110 calculates the number of appearances (appearance frequency) of the tokens in the text data, which are extracted by the morpheme analysis unit 109, and stores the calculated result in the index information table 112.

The content identifier extraction unit 111 refers to the index information table 112 and the DF storage table 113 thereby determining a set of tokens used for identifying the electronic file as a content identifier. Then, the content identifier extraction unit 111 transmits the determined content identifier via the network interface 206.

The text extraction unit 108, the morpheme analysis unit 109, the index information acquisition unit 110, and the content identifier extraction unit 111 are realized by executing programs (not shown) read from the memory 203 by the CPU 201, which is described later.

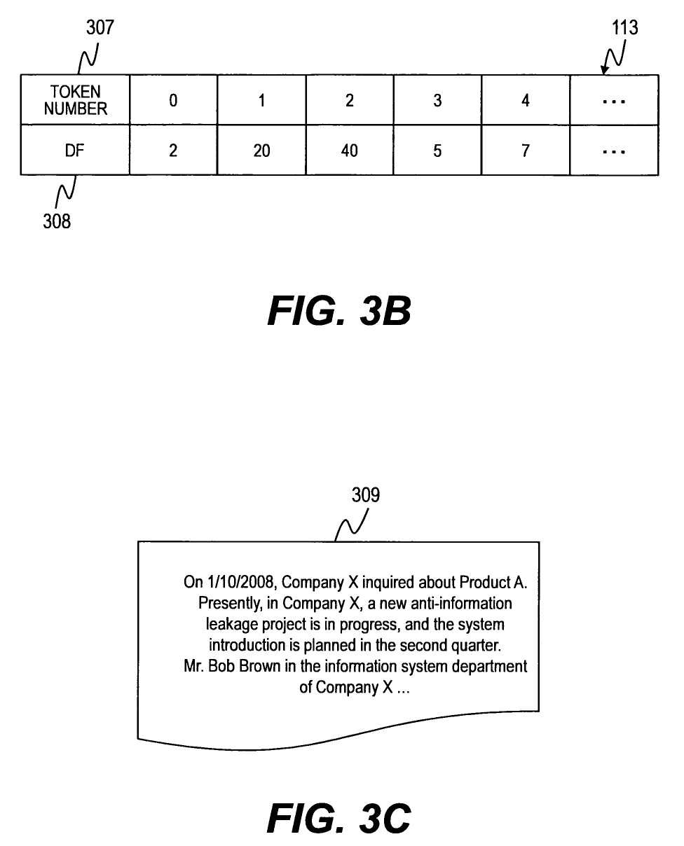

The index information table 112 is stored in the storage 202, which is described later, and manages the number of appearances of tokens in text data. The index information table 112 will be described later referring to FIG. 3A.

The DF storage table 113 is stored in the storage 202, which is described later, and manages the number of electronic files in which respective tokens appear. The DF storage table 113 will be described later referring to FIG. 3B.

The content identifier table 106 is stored in the storage 202, which is described later, and manages information on content identifiers for identifying electronic files. The content identifier table 106 will be described later referring to FIG. 4.

The client computer 103 is a computer used by a user of electronic files, and includes the trail acquisition unit 114.

The trail acquisition unit 114 acquires, when the client computer 103 stores an electronic file in the storage 202, a user ID of the client computer 103, an electronic file ID, storage date and time, and the like as usage trail data, and transmits the stored electronic file and the acquired usage trail data to the document-usage-trail management server 101 via the network interface 206. The document-usage-trail management server 101 stores the usage trail data received from the trail acquisition unit 114 of the client computer 103 in the document usage trail table 105.

The trail acquisition unit 114 is realized by executing a program (not shown) read from the memory 203 by the CPU 201, which is described later.

In the example illustrated in FIG. 1, two of the client computer's 103 are provided for the system, but three or more of the client computer's 103 may be provided for the system.

Moreover, the document-usage-trail management server 101, the content identifier assigning server 102, and the client computer 103 are described as independent devices, but may be implemented as a single hardware device.

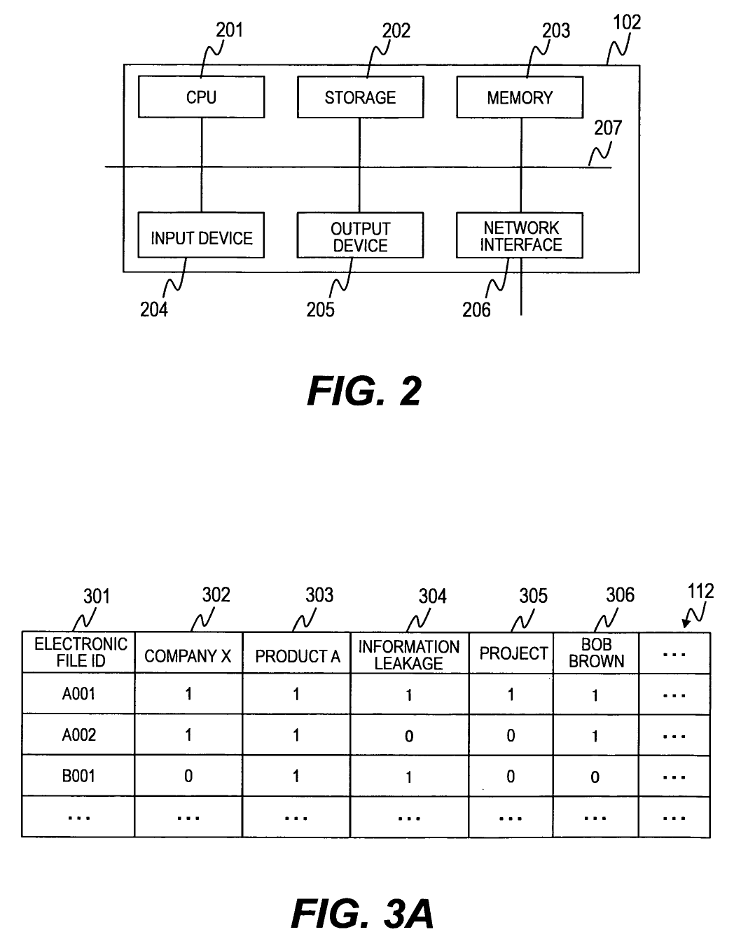

Next, referring to FIG. 2, a description will be given of a hardware configuration of the content identifier assigning server 102.

FIG. 2 is a block diagram illustrating the hardware configuration of the content identifier assigning server 102 according to the first embodiment of this invention.

The content identifier assigning server 102 includes the central processing unit (CPU) 201, the storage 202, the memory 203, an input device 204, the output device 205, and the network interface 206. The CPU 201, the storage 202, the memory 203, the input device 204, the output device 205, and the network interface 206 are respectively coupled to a bus 207.

The CPU 201 is a processor which executes programs stored in the memory 203 thereby controlling the entire hardware.

The memory 203 stores programs executed by the CPU 201. The memory 203 may be constructed of a semiconductor memory such as a random access memory (RAM). Moreover, programs and data stored in the storage 202 are read when necessary, and are stored in the memory 203.

The storage 202 stores programs and data, and may be constructed of a storage medium such as a compact disk-recordable (CD-R), a digital versatile disk-random access memory (DVD-RAM), and a silicon disk, a drive device for the storage medium, a hard disk drive (HDD), or the like.

The input device 204 is a device for receiving an input of information carried out by a user, and may be constructed of a keyboard, a mouse, a scanner, a microphone, or the like.

The output device 205 is a device for showing information directed to a user, and may be constructed of a display device, a speaker, a printer, or the like.

The network interface 206 is an interface for coupling to the communication network 104, and may be constructed of a local area network (LAN) board and the like.

It should be noted that the document-usage-trail management server 101 and the client computer 103 have the same configuration as the hardware configuration illustrated in FIG. 2.

FIG. 3A describes the index information table 112 according to the first embodiment of this invention.

The index information table 112 includes electronic file IDs 301, a field for information on a token “Company X” 302, a field for information on a token “Product A” 303, a field for information on a token “Information leakage” 304, a field for information on a token “Project” 305, and a field for information on a token “Bob Brown” 306. It should be noted that a row of data in the index information table 112 is a record.

The electronic file ID 301 indicates an identifier assigned to an electronic file. It should be noted that an identifier assigned to an electronic file is uniquely identifiable in the system illustrated in FIG. 1.

As illustrated in FIG. 3A, the fields includes the field for the token “Company X” 302, the field for the token “Product A” 303, the field for the token “Information leakage” 304, the field for the token “Project” 305, and the field for the token “Bob Brown” 306. When a new electronic file is registered to the index information table 112, fields may be added for storing information on other tokens.

Values of the fields corresponding to the respective electronic files in the index information table 112 indicate states of the tokens contained in the respective electronic files. Specifically, a value “1” indicates at least one token is contained in an electronic file. A value “0” indicates that the token is not contained in the electronic file.

FIG. 3B describes the DF storage table 113 according to the first embodiment of this invention.

The DF storage table 113 includes token numbers 307 and DFs 308.

The token number 307 is a management number assigned to respective tokens. For example, it is possible to sequentially assign token numbers 0, 1, 2, . . . to the tokens stored in the index information table 112 illustrated in FIG. 3A. The DF 308 is the number of electronic files in which the respective tokens appear (document frequency (DF)). For example, for the respective electronic files in the index information table 112 illustrated in FIG. 3A, the sum of values in the field for the token “Company X” 302 is the number of electronic files in which the token “Company X” appears.

In the example illustrated in FIG. 3B, the management number of the token “Company X” is “0”, and the number of electronic files in which the token “Company X” appears is “2”.

FIG. 3C describes an example of an electronic file 309 according to the first embodiment of this invention.

The electronic file 309 illustrated in FIG. 3C is an electronic file 309 to be stored in the storage 202 of the client computer 103, for example. When the electronic file 309 is stored in the storage 202 of the client computer 103, the trail acquisition unit 114 transmits the stored electronic file 309 and the usage trail data to the document-usage-trail management server 101.

FIG. 4 describes the document usage trail table 105 according to the first embodiment of this invention.

The document usage trail table 105 includes users 401, clients 402, electronic file IDs 403, and creation dates and times 404. It should be noted that a row of data in the document usage trail table 105 is a record. Respective records are usage trail data of an electronic file received from the client computer 103.

The user 401 is an identifier for identifying a user of the client computer 103. The client 402 is an identifier for identifying the client computer 103.

The electronic file ID 403 is an identifier assigned to an electronic file. The electronic file ID 403 is, for example, as illustrated in FIG. 4, may be an identifier created by concatenating the identifier of a client 402 storing the electronic file and a serial number of the electronic file allocated for the respective clients 402.

The creation date and time 404 is the date and time when the electronic file was created. The creation date and time 404 is, for example, the date and time when a user stores an electronic file on the operating client computer 103 such as the date and time when a duplicated electronic file (duplicated file) is stored via the input device 204, the date and time when a duplicated file is received via the network interface 206, and the like. In the example illustrated in FIG. 4, integers in eight digits representing a year, a month, and a day are stored, and a time is omitted.

The document usage trail table 105 illustrated in FIG. 4 is in table form, but the document usage trail table 105 may be in any data form such as the extensible markup language (XML).

Moreover, as the usage trail data, other data (such as IP address) than the data illustrated in FIG. 4 may be stored in the document usage trail table 105.

FIG. 5 describes the content identifier table 106 according to the first embodiment of this invention.

The content identifier table 106 includes electronic file IDs 501 and content identifiers 502.

The electronic file ID 501 is an identifier assigned to an electronic file, and corresponds to the electronic file ID 403 stored in the document usage trail table 105 illustrated in FIG. 4.

The content identifier 502 is a token which uniquely identifies an electronic file extracted from text data.

In an example illustrated in FIG. 5, a set of tokens {Company X, Product A, Bob Brown} is a content identifier for identifying an electronic file “A001”. Moreover, a set of tokens {Company Y, Angela Brown} is a content identifier for identifying an electronic file “B001”. Further, a set of tokens {Company X, Product A, Bob Brown} is a content identifier for identifying an electronic file “B002”.

It should be noted that the electronic file “B002” has the same content identifier as that of the electronic file “A001”. In this case, it is shown that the electronic file “A001” and the electronic file “B002” are different files, but have the same contents (contents of the text data).

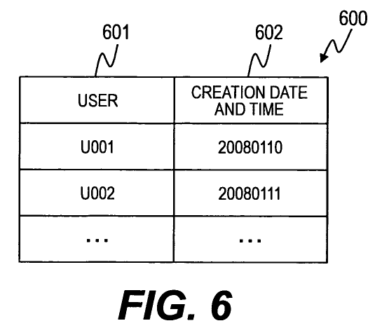

FIG. 6 describes output data 600 of the trail analysis unit 107 according to the first embodiment of this invention.

The output data 600 illustrated in FIG. 6 includes users 601 and creation dates and times 602.

The user 601 is an identifier for identifying a user of the client computer 103, and corresponds to the user 301 stored in the document usage trail table 105 illustrated in FIG. 4. The creation date and time 602 is the date and time when the electronic file was created, and corresponds to the creation date and time 404 stored in the document usage trail table 105 illustrated in FIG. 4.

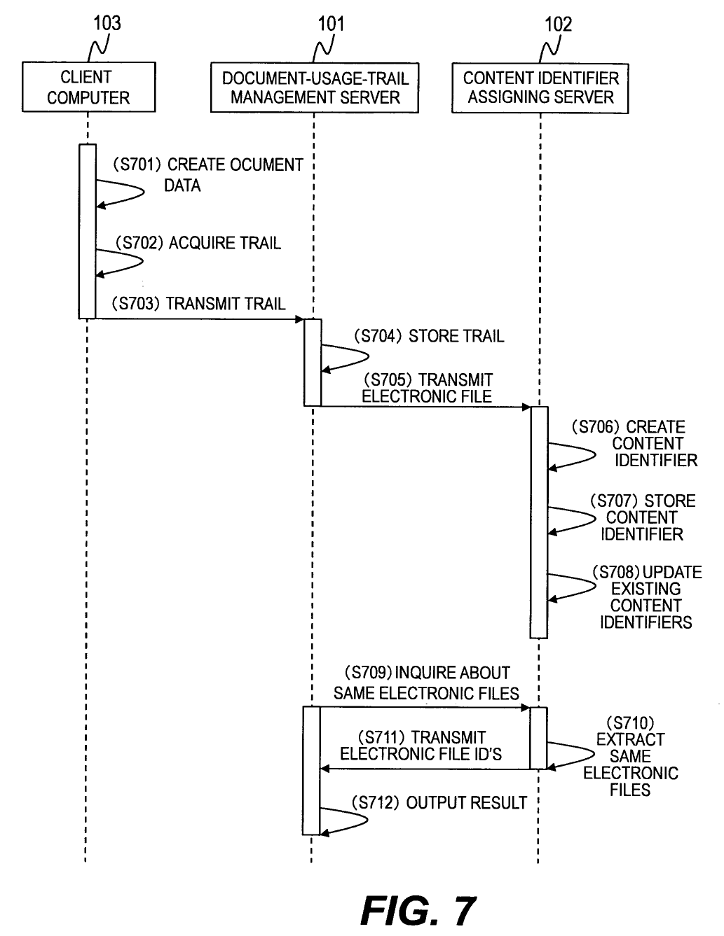

The trail analysis unit 107 submits, when an administrator of the document-usage-trail management server 101 specifies one electronic file, an inquiry with the content identifier assigned to the specified electronic file as a search key to the content identifier assigning server 102. When there is a content identifier coincident with the content identifier specified as the search key, the content identifier assigning server 102 outputs a list of users owning respective electronic files and dates and times when the respective electronic files were used. A description will later be given of processing for outputting the output data 600 referring to FIG. 7.

The example illustrated in FIG. 6 is a result of analysis of a user (U002) of the client computer 103 owning the electronic file “A001” and the copy (B001) of the electronic file “A001” showing that a user “U001” and the user “U002” own the electronic file “A001” or the electronic file including the same content as that of the electronic file “A001”.

FIG. 7 describes a processing sequence according to the first embodiment of this invention.

The processing illustrated in FIG. 7 is executed by executing the programs stored in the memories 203 by the CPU's 201 provided for the respective devices.

First, the client computer 103 creates text data, and stores the created text data as an electronic file in the storage 202 (S701).

Then, the trail acquisition unit 114 of the client computer 103 acquires the usage trail data of the electronic file stored in Step S701 (S702).

In Step S702, the electronic file 309 illustrated in FIG. 3C and values of the usage trail data to be stored in the document usage trail table 105 are acquired. As the values to be stored in the document usage trail table 105, as the user 401, an identifier (such as logon name) of a user using the client computer 103 when the electronic file was stored.

Moreover, as the client 402, an identifier for identifying the client computer 103 (such as host name) is acquired. Moreover, as the electronic file ID 403, an identifier to be assigned to the electronic file (such as the identifier created by concatenating the identifier for identifying the client computer 103 and the serial number of the electronic file managed by the trail acquisition unit 114) is acquired. Moreover, as the creation date and time 404, the date and time when the electronic file was created on (stored in) the client computer 103 is acquired.

It should be noted that, in Step S702, it is not necessary for the client computer 103 to acquire the usage trail data corresponding to the creation date and time 404. In this case, as described later, after the document-usage-trail management server 101 receives the usage trail data, the value of the creation date and time 404 is stored in the document usage trail table 105.

Then, the trail acquisition unit 114 of the client computer 103 transmits the electronic file stored in Step S701 and the usage trail data acquired in Step 702 to the document-usage-trail management server 101 (S703).

Then, the document-usage-trail management server 101 stores the usage trail data received in Step S703 in the document usage trail table 105 (S704).

In Step S704, the document-usage-trail management server 101 first compares the identifier of the electronic file contained in the received usage trail data and the electronic file IDs 403 stored in the document usage trail table 105. When the same electronic file ID 403 is present, the document-usage-trail management server 101 overwrites the usage trail data on the corresponding record. On the other hand, when the same electronic file ID 403 is absent, the usage trail data is added as a new record to the document usage trail table 105. When the creation date and time 404 is not contained in the received usage trail data, the date and time when the document-usage-trail management server 101 received the usage trail data is stored as the creation date and time 404.

Then, the document-usage-trail management server 101 transmits the electronic file received in Step S703 to the content identifier assigning server 102 (S705).

Then, the content identifier assigning server 102 creates a content identifier of the electronic file received in Step S705 (S706). As described before, the content identifier is a set of tokens which can uniquely identify an electronic file. It should be noted that a detailed description will be given of the processing of Step S706 referring to FIG. 8.

Then, the content identifier assigning server 102 stores the identifier of the electronic file contained in the usage trail data received in Step S705 and the content identifier created in Step S706 in the content identifier table 106 (S707).

In Step S707, the content identifier assigning server 102 deletes, when the identifier of the received electronic file exists in the content identifier table 106, a corresponding content identifier 502 of the content identifier table 106, and adds the content identifier created in Step 706. On the other hand, the content identifier assigning server 102 adds, when the identifier of the electronic file to be stored does not exist in the content identifier table 106, the identifier of the received electronic file and the content identifier created in Step 706 to the content identifier table 106 as a new record.

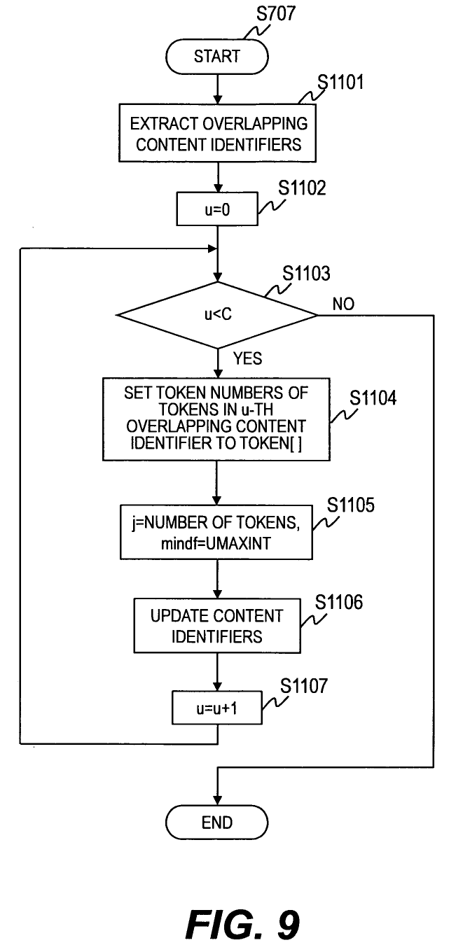

Then, the content identifier assigning server 102 refers to the content identifier table 106, and updates other content identifiers which collide (coincide) with a part of the content identifier stored in Step S707 (S708). It should be noted that a detailed description will be given of the processing of Step S708 referring to FIG. 9.

The operations from Step S701 to Step S708 are successively carried out as a series of operations after Step S701 is carried out. In other words, each time when the client computer 103 stores an electronic file in the storage 202, the document usage trail table 105 of the document-usage-trail management server 101 and the content identifier table 106 of the content identifier assigning server 102 are updated.

Next, a description will be given of processing from Step S709 to Step S712. Steps S709 to S712 are carried out at an arbitrary timing by the administrator of the document-usage-trail management server 101.

First, when the administrator inputs an identifier of an electronic file the usage of which the administrator wants to know in the trail analysis unit 107 via the input device 204, the document-usage-trail management server 101 transmits the input identifier of the electronic file to the content identifier assigning server 102 thereby inquiring the content identifier assigning server 102 about whether other electronic files whose identifier coincides with the input identifier of the electronic file exist or not (S709).

Then, the content identifier assigning server 102 refers to the content identifier table 106 thereby extracting other electronic files to which the same content identifier as the content identifier of the electronic file received in Step S709 is assigned (S710).

In Step S710, first, the content identifier assigning server 102 refers to the electronic file IDs 501 of the content identifier table 106, and identifies content identifiers 502 corresponding to the identifier of the electronic file received in Step S709. Then, the content identifier assigning server 102 refers to the content identifiers 502 thereby extracting electronic file IDs 501 containing the content identifiers 502 entirely coinciding with the identified content identifiers 502.

Then, the content identifier assigning server 102 transmits the electronic file IDs 501 extracted in Step S710 to the document-usage-trail management server 101 (S711).

Then, the trail analysis unit 107 of the document-usage-trail management server 101 refers to the document usage trail table 105, identifies records the electronic file IDs 403 of which coincide respectively with the identifier of the electronic file input in Step S709 and the electronic file IDs 501 extracted in Step S710, and acquires the user's 401 and the creation dates and times 404 of the identified records. The trail analysis unit 107 outputs a list created based on the acquired user's 401 and creation dates and times 404 in the form of the output data 600 illustrated in FIG. 6 (S712).

In this way, by executing the processing of Steps S706 and S708 illustrated in FIG. 7, it is possible, as described later, to assign a set of tokens the DF of which is “1” as a content identifier. Moreover, by identifying contents using an assigned token set, as the processing of Steps S709 to S712 illustrated in FIG. 7 illustrates, files which have the same content, but exist on different client computer's 103 can be easily traced.

FIG. 8 is a flowchart illustrating the processing for creating a content identifier according to the first embodiment of this invention.

First, the text extraction unit 108 extracts text data from data stored in the electronic file (S801). The processing for extracting the text data can be realized by employing a conventional technology. For example, the processing can be realized by an export feature of an application program for creating an electronic file or an interface provided by a software development kit (SDK) of an application program for creating an electronic file.

Then, the morpheme analysis unit 109 carries out morpheme analysis processing on the text data extracted in Step S801 (S802). The morpheme analysis is processing for decomposing sentences contained in the text data into elements (morphemes) which are the minimum units of a string, and discriminating the decomposed morphemes into parts of speech.

The morpheme analysis processing is carried out in Step S802, but a subset of the text data may be randomly extracted as a token.

It should be noted that the morpheme analysis can be realized by employing a conventional technology. For example, the morpheme analysis can be realized by the hidden Markov model (HMM), a tool by Yuji Matsumoto et al. disclosed in “ChaSen Morphological Analyzer version 2.4.0 User's Manual”, Yuji Matsumoto and Kazuma Takaoka and Masayuki Asahara, Computational Linguistics Laboratory Graduate School of Information Science, Nara Institute of Science and Technology, March, 2007, or the like.

Then, the index information acquisition unit 110 specifies at least a part of the morphemes discriminated in Step S802 as “tokens”, and counts frequencies of appearance of the respective specified tokens. Then, a result of the count is stored in the index information table 112 (S803).

In Step S803, the index information acquisition unit 110 first adds new fields to the index information table 112, and stores the specified tokens in the added fields. To the newly added fields, of the tokens discriminated by the above-mentioned morpheme analysis, tokens which are not stored in the index information table 112 are stored. For the respective records in the index information table 112, the values in the newly added fields are “0”.

Then, the index information acquisition unit 110 adds a record corresponding to the identifier of the electronic file to the index information table 112. Then, the index information acquisition unit 110 counts the frequency of appearance of the tokens extracted from the electronic file and then registered to the index information table 112, and stores the counts to the respective fields of the newly added record. Then, the index information acquisition unit 110 sums the values of the respective fields in the index information table 112, and stores the sums in the DFs 308 of the DF storage table 113.

The morphemes specified as tokens are not specifically limited, but the morpheme specified as token is “noun” according to this embodiment.

Moreover, the processing of Step S803 can be realized by a conventional technology. For example, the processing can be realized by a tool by Akihiko Takano et al. disclosed in “Information Access based on Associative Calculation”, In Lecture Notes in Computer Science LNCS: 1963, Springer, 2000., or the like.

Then, the content identifier extraction unit 111 refers to the DF storage table 113, and sorts the tokens in terms of the DF 308 in ascending order. The token numbers 307 of the sorted respective tokens are stored sequentially in an array Token [ ] of a size M′ (S804). On this occasion, the size M′ is the number of elements constituting the set of tokens (token set), namely the number of the tokens stored in the index information table 112. The values to be stored in the array TOKEN[ ] are the token numbers 307 of the index information table 112. By sorting the tokens in ascending order in terms of the DF 308, it is possible to quickly extract a combination of tokens the DF of which is “1”, resulting in an increase in processing efficiency.

Then, the content identifier extraction unit 111 initializes a counter variable j, which represents which token is under processing, to “0”, initializes a variable s, which is the number of tokens constructing the content identifier, to “0”, and initializes a variable mindf, which stores a DF under processing, to a unsigned integer constant UMAXINT (S805). The constant UMAXINT represents the possible maximum value of the variable mindf, and is determined in advance by specifications of the CPU 201 which executes the sequence processing illustrated in FIG. 8. For example, when the sequence processing illustrated in FIG. 8 is implemented by a general computer language such as the C language, the constant UMAXINT is provided as a system constant.

Then, the content identifier extraction unit 111 determines whether the processing has been completed for all the elements in the array TOKEN[ ] or not (whether j<M′ or not), and whether a token set whose DF is “1” exists or not (whether mindf>1 or not) (S806).

When the counter variable j is less than the size M, and the variable mindf is more than “1”, the processing proceeds to Step S807. On the other hand, when the counter variable j is equal to or more than the size M′, or the variable mindf is equal to or less than “1”, the processing proceeds to Step S819.

The processing from Step S806 to Step S818 counts the DFs for a combination of a token corresponding to the array TOKEN[j] and other tokens.

Then, the content identifier extraction unit 111 initializes a variable df, which stores the DFs of the token set to “0” (S807), and initializes a counter variable i, which refers to a record in the index information table 112, to “0” (S808).

Then, the content identifier extraction unit 111 determines whether the counter variable i is smaller than the number N of the records stored in the index information table 112 (S809). When the counter variable i is smaller than the number N of the records, the processing proceeds to Step S810. On the other hand, when the counter variable i is equal to or larger than the number N of the records, the processing proceeds to Step S816.

Then, the content identifier extraction unit 111 initializes a counter variable k, which individually refers to an element of a token set which is a candidate of the content identifier, to “0” (S810).

Then, the content identifier extraction unit 111 refers to a record under processing in the index information table 112, and determines whether the counter variable k is equal to or less than the counter variable j and the value in an array F[i][TOKEN[k]] is greater than “0” (S811). In other words, in Step S811, the content identifier extraction unit 111 determines whether the frequency of appearance has been calculated for all the candidate tokens of the content identifier, and whether the candidate token of the content identifier exists in the i-th record in the index information table 112. On this occasion, F[X][Y] denotes a value stored at the intersection of an X-th record and a Y-th field in the index information table 112.

When the counter variable k is equal to or less than the counter variable j, and the value in the array F[i][TOKEN[k]] is larger than “0”, the processing proceeds to Step S812. On the other hand, when the counter variable k is larger than the counter variable j, or the value in the array F[i][TOKEN[k]] is equal to or less than “0”, the processing proceeds to Step S813.

Then, the content identifier extraction unit 111 increments the counter variable k by 1 (k=k+1) (S812). Then, the processing returns to Step S811.

In Step S813, the content identifier extraction unit 111 determines whether the counter variable k is equal to the counter variable j. In other words, in Step S813, the content identifier extraction unit 111 determines whether all the candidate tokens of the content identifier exist in the i-th record of the index information table 112.

When the counter variable k is equal to the counter variable j, the processing proceeds to Step S814. On the other hand, when the counter variable k is not equal to the counter variable j, the processing proceeds to Step S815.

Then, the content identifier extraction unit 111, because, in the i-th record of the index information table 112, F[i][TOKEN[0]], F[i][TOKEN[1]], . . . . F[i][TOKEN[j]] are respectively larger than 0, increments the variable df, which represents the DF of the token set, by 1 (df=df+1) (S814).

Then, the content identifier extraction unit 111 increments the counter variable i indicating the record under processing in the index information table 112 by 1 (i=i+1) (S815). Then, the processing returns to Step S809.

In Step S816, the content identifier extraction unit 111 determines whether the variable df is less than the variable mindf. In other words, the content identifier extraction unit 111 determines whether, for the token set under processing, the variable df calculated by referring to all the records is less than the minimum value of the variable df calculated for the token sets for which the processing has been completed.

When the variable df is less than the variable mindf, the processing proceeds to Step S817. On the other hand, when the variable df is equal to or more than the variable mindf, the processing proceeds to Step S818.

Then, the content identifier extraction unit 111 stores the value of the variable df in the variable mindf, and stores the value of the counter variable j in the variable s (S817).

Then, the content identifier extraction unit 111 increments the counter variable j by 1 (j=j+1) (S818). Then, the processing returns to Step S806.

In Step S819, the content identifier extraction unit 111 outputs TOKEN[0], TOKEN[1], . . . , TOKEN[s] as the content identifier (S819). The value of the variable s upon the execution of the processing of Step S819 is any one of (1) the value of the counter variable j when the variable df reached 1 and (2) the value of the counter variable j when the variable df reached the minimum value larger than “1” for the first time. The processing in which the variable s stores the value of (2) is required when electronic files having exactly the same text data such as duplicated files exist. When the value of (2) is stored in the variable s, it is not necessary to output all the tokens as the content identifier even when electronic files having exactly the same text data exist. Specifically, the value of the counter variable j is stored in the variable when the variable mindf reached the number of same electronic files.

The above-mentioned description is given of the processing carried out in Step S706 of FIG. 7, and, when the new content identifier is created in Step S706, DFs of the content identifiers 502 already stored in the content identifier table 106 may become two or more in some cases.

A description will now be given of the example illustrated in FIG. 5. When, as a new content identifier 502 for an electronic file “A002”, a token set {Company X, Product A, Bob Brown, Rival company Y} is added, a part of the token set {Company X, Product A, Bob Brown} coincides with the content identifier 502 of the electronic file “A001”. Thus, when the content identifier “Company X, Product A, Bob Brown” is used later to identify electronic files, the electronic file “A001” and the electronic file “A002” are detected.

According to this embodiment, in order to avoid this situation, in Step S708 of FIG. 7, the content identifier assigning server 102 refers to the content identifiers already stored in the content identifier table 106, and, when the content identifier of a newly added electronic file and content identifiers already stored in the content identifier table 106 overlap, updates the content identifiers.

FIG. 9 is a flowchart illustrating the processing for updating content identifiers according to the first embodiment of this invention.

First, the content identifier assigning server 102 refers to the content identifier table 106, and extracts other content identifiers (overlapping content identifiers) 502 coinciding with a part of the content identifier 502 newly added in Step S707 of FIG. 7, and the electronic file IDs 501 of the overlapping content identifiers 502 (S1101). In the example described above, when the content identifier “Company X, Product A, Bob Brown, Rival company Y” is newly added, the content identifier “Company X, Product A, Bob Brown”, and the electronic file ID “A001” are extracted.

Then, the content identifier assigning server 102 initializes a counter variable u to “0” used for sequentially referring to the content identifiers extracted in Step S1101 (S1102).

Then, the content identifier assigning server 102 determines whether the counter variable u is less than a variable C. On this occasion, the variable C indicates the number of the content identifiers extracted in Step S1101.

When the variable u is less than the variable C, the processing proceeds to Step S1104. On the other hand, when the variable u is equal to or more than the variable C, the processing is finished.

Then, the content identifier assigning server 102 uses tokens contained in an electronic file corresponding to a u-th overlapping content identifier and DFs 308 of the respective tokens, thereby storing the token numbers in the array TOKEN[ ] (S1104). The processing of Step S1104 is the same as the processing of Step S804 of FIG. 8.

In the above-mentioned example, the token numbers 307 of the tokens of the content identifier (“Company X”, “Product A”, “Bob Brown”) contained in the electronic file “A001” are stored in the array TOKEN[ ]. In other words, in TOKEN[0], TOKEN[1], and TOKEN[2], the token number “0” of “Company X”, the token number “1” of “Product A”, and the token number “4” of “Bob Brown” are stored, respectively. Then, the other tokens contained in the electronic file “A001” are sorted in ascending order in terms of the DF 308, and the token numbers 307 of the respective sorted tokens are sequentially stored in a portion of the array starting from TOKEN[3].

Then, the content identifier assigning server 102, in order to search for tokens to be newly added to the content identifier, initializes the counter variable j for sequentially referring to the array TOKEN[ ], and initializes the variable mindf for storing the DF of the token set under processing to UMAXINT (S1105).

It should be noted that, in the following processing, the content identifier assigning server 102 refers to TOKEN[ ] by adding tokens to the token set already set as the content identifier, and hence the content identifier assigning server 102 stores the number of tokens contained in the u-th overlapping content identifier in the initial value of the counter variable j. In the above-mentioned example, the content identifier “Company X, Product A, Bob Brown” contains three tokens, and hence “3” is stored in the counter variable j, thereby initializing the counter variable j to the state in which the subsequent processing starts from the TOKEN[3].

Then, in Step S1106, the content identifier assigning server 102 updates the content identifier by adding new tokens to the array TOKEN[ ] (S1106). It should be noted that processing of Step S1106 is the same as the processing from Step S806 to Step S818 of FIG. 8. In the example described above, to the token set {Company X, Product A, Bob Brown}, tokens TOKEN[3], TOKEN[4], . . . are sequentially added, and a token set acquired when DF=1 is set to a new content identifier.

Then, the content identifier assigning server 102 increments the counter variable u by 1 (u=u+1) (S1107). Then, the processing returns to Step S1103.

The first embodiment of this invention has been described above.

According to this embodiment, in the processing of Step S706 of FIG. 7, one content identifier, namely one token set, is assigned to one electronic file, but, by randomly selecting the tokens in Step S804 of FIG. 8, and, then, repeating the processing from Step S805 to Step S818, two or more content identifiers may be assigned to one electronic file.

By redundantly assigning content identifiers in this way, the possibility of coincidence with the other content identifiers decreases, and it is thus possible to reduce the quantity of processing for updating overlapping content identifiers in Step S708 of FIG. 7. Moreover, the content identifiers are redundantly assigned, and hence it is possible to increase a resistance of the electronic file.

According to the first embodiment of this invention, by employing text information stored in an electronic file, it is possible to assign an identifier for uniquely identifying the electronic file.

Moreover, it is possible to recognize electronic files being communicated in an organization, and to trace electronic files held by system users in the organization.

Moreover, this embodiment can be applied to information security products such as the data leakage prevention (DLP) and security monitoring intended for information leakage prevention.

### Second Embodiment

According to a second embodiment of this invention, when an electronic mail is transmitted, by comparing the electronic mail with confidential information registered in advance, and controlling the transmission of the electronic mail, leakage of confidential information is prevented.

For the sake of simplicity of description, like components are denoted by like numerals as those of the first embodiment, and will not be further explained.

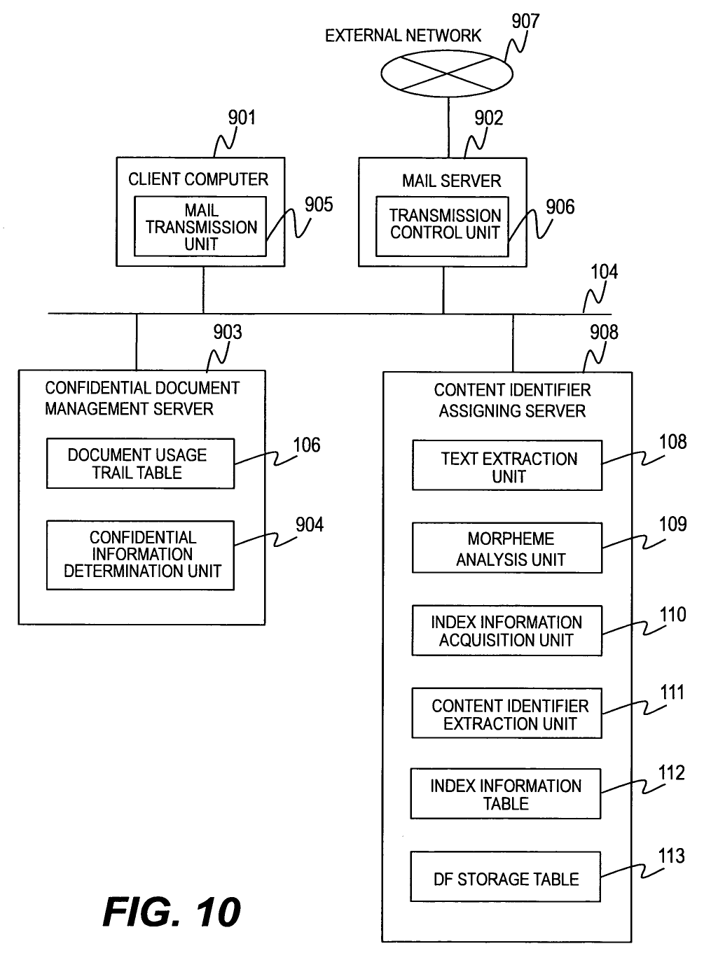

Referring to FIG. 10 first, a description will be given of a configuration of a system according to the second embodiment of this invention.

FIG. 10 is a block diagram of the configuration of the system according to the second embodiment of this invention.

As illustrated in FIG. 10, the system according to the second embodiment includes a content identifier assigning server 908, a client computer 901, a mail server 902, and a confidential document management server 903. The content identifier assigning server 908, the client computer 901, the mail server 902, and the confidential document management server 903 are respectively coupled to the communication network 104. It should be noted that the mail server 902 is coupled to an external network 907.

The external network 907 is, for example, a WAN coupling between branches, a local IP network, or the Internet.

The content identifier assigning server 908, the client computer 901, the mail server 902, and the confidential document management server 903 have the same configuration as the hardware configuration illustrated in FIG. 2.

The client computer 901 includes a mail transmission unit 905. The mail transmission unit 905 attaches an electronic file or the like to an electronic mail, and transmits the resulting electronic mail. It should be noted that, by reading a program (not shown) from the memory 203, and executing the program, the mail transmission unit 905 is realized.

The mail server 902 includes a transmission control unit 906. The transmission control unit 906 controls electronic mails transmitted from the client computer 901. It should be noted that, by reading a program (not shown) from the memory 203, and executing the program, the transmission control unit 906 is realized.

The confidential document management server 903 includes a confidential information determination unit 904 and the content identifier table 106.

The confidential information determination unit 904 determines whether data contained in a mail to be transmitted from the client computer 901 is confidential information or not. It should be noted that, by reading a program (not shown) from the memory 203, and executing the program, the confidential information determination unit 904 is realized.

The content identifier table 106 is the same as the content identifier table 106 of FIG. 1, and will not be further explained.

The content identifier assigning server 908 is different from the content identifier assigning server 102 according to the first embodiment in that the content identifier table 106 is omitted. The other configuration thereof is the same as that of the content identifier assigning server 102 illustrated in FIG.

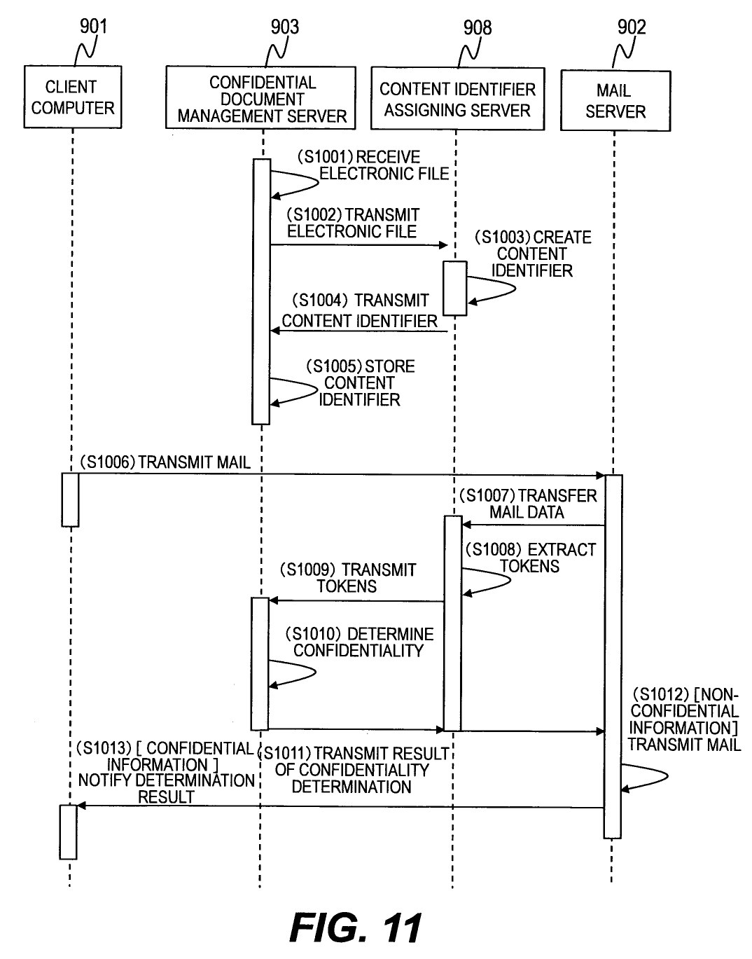

FIG. 11 describes a processing sequence according to the second embodiment of this invention.

The processing illustrated in FIG. 11 is executed by executing the programs stored in the memories 203 by the CPU's 201 provided for the respective devices.

First, processing from Step S1001 to Step S1005 registers confidential information to the confidential document management server 903 in advance. The registration processing of the confidential information is started manually by a user of the system, or started by the confidential document management server 903 storing electronic files containing confidential documents or the client computer 901.

First, the confidential document management server 903 receives an electronic file storing a confidential document (S1001).

Then, the confidential document management server 903 transmits, in order to assign a content identifier to the electronic file received in Step S1001, the received electronic file to the content identifier assigning server 908 (S1002).

Then, the content identifier assigning server 908 creates a content identifier from the electronic file received in Step S1002 (S1003). The processing of Step S1003 is the same as the above-mentioned processing of Step S706 of FIG. 7, namely the processing from Step S801 to Step S818 of FIG. 8.

Then, the content identifier assigning server 908 transmits the content identifier created in Step S1003 to the confidential document management server 903 (S1004).

Then, the confidential document management server 903 stores the content identifier received in Step S1004 in the content identifier table 106 (S1005). According to this embodiment, the value stored in the electronic file ID 501 of the content identifier table 106 is a serial number assigned to the electronic file by the confidential document management server 903.

Next, a description will be given of processing for determining confidentiality upon transmission of an electronic mail carried out by steps S1006 to S1013.

First, the client computer 901 transmits an electronic mail to the mail server 902 (S1006). The transmission of the electronic mail can be realized by a conventional technology such as the simple mail transfer protocol (SMTP).

Then, the transmission control unit 906 of the mail server 902 transfers, in order to determine whether the electronic mail received in Step S1006 can be transmitted or not, the received electronic mail to the content identifier assigning server 908 (S1007).

Then, the content identifier assigning server 908 extracts tokens from the electronic mail received in Step S1007 (S1008). The processing of Step S1008 is the same as that from Step S801 to Step S803 of FIG. 8. According to this embodiment, a result of the processing of Step S803 is not stored in the index information table 112, and is used for processing starting from Step S1009. Moreover, the tokens are extracted from the subject of the mail header, the body of the mail, the attachment, and the like in the electronic mail. The locations from which the tokens are extracted are set in advance by an administrator of the content identifier assigning server 908.

Moreover, the tokens extracted in Step S1008 may be only “noun” tokens of tokens extracted by the above-mentioned morpheme analysis. Moreover, tokens may be randomly selected tokes of the tokens extracted by the morpheme analysis. Moreover, tokens may be only tokens the DF of which is larger than a predetermined value of the tokens extracted by the morpheme analysis.

Then, the content identifier assigning server 908 transmits the tokens extracted in Step S1008 to the confidential document management server 903 (S1009).

Then, the confidential document management server 903 compares the tokens received in Step S1009 and the content identifier table 106, thereby determining whether the electronic mail from which the tokens are extracted in Step S1008 contains confidential information or not (S1010). Specifically, the confidential document management server 903 selects one content identifier 502 stored in the content identifier table 106 at a time, and determines, when the token set contained in the selected content identifier 502 is contained in the tokens received in Step S1009, that the electronic mail “contains confidential information”. When any content identifiers 502 are not contained in the tokens, the confidential document management server 903 determines that the electronic mail “does not contain confidential information”.

Then, the confidential document management server 903 transmits a result of the determination in Step S1010 to the content identifier assigning sever 908. The content identifier assigning server 908 transmits the received result of the determination to the transmission control unit 906 of the mail server 902 (S1011).

Then, the transmission control unit 906 of the mail server 902 transmits, when the determination result received in Step S1011 is that the electronic mail “does not contain confidential information”, the electronic mail received in Step S1006 to an address specified by the electronic mail (S1012). On the other hand, when the determination result is that the electronic mail “contains confidential information”, the transmission control unit 906 of the mail server 902 stops the transmission of the electronic mail, and notifies the client computer 901 of the determination result of confidentiality (S1013).

The system according to the second embodiment of this invention extracts, in advance, a content identifier the DF of which is “1” from a confidential document by the processing of Step S1003 of FIG. 11, and can employ the content identifier for the determination for the confidential information in Step S1010. Moreover, by employing the content identifier, even when the name of an electronic file containing confidential information has been changed, it is possible to determine the identity based on contents of the electronic file. Moreover, by employing a content identifier the DF of which is “1”, even when the number of pieces of the registered confidential information is large, it is possible to make determination while employing only coincident confidential information. Therefore, compared with a conventional technology, it is possible to reduce a false determination notified to a client computer.

According to the second embodiment of this invention, in an electronic mail server, by comparing an identifier of an electronic file assigned to a mail to be transmitted with registered electronic files containing confidential information, it is possible to prevent confidential information from leaking via electronic mails.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. An information identification device for assigning an identifier to an electronic file based on data stored in the electronic file, comprising:
an interface coupled to a network; a processor coupled to the interface; and
a memory coupled to the processor, the information identification device being configured to:
calculate a frequency of appearance of a word in text data included in the electronic file;
determine an identifier capable of uniquely identifying the electronic file based on the calculated frequency of appearance; and
assign the determined identifier to the electronic file.

2. The information identification device according to claim 1, being further configured to:
extract text data from the data included in the electronic file;
extract words included in the extracted text data;
calculate a frequency of appearance of the extracted words in the text data in order to store in index information;
sort the words included in the electronic file in ascending order in terms of appearance frequency of words stored in the index information;
sequentially select the words in the sorted order;
produce a word set from at least one of the selected words;
judge whether the electronic file can be uniquely identified in the case where the produced word set coincides with an identifier assigned to another electronic file; and
determine the word set as the identifier of the electronic file in a case where the produced word set can uniquely identify the electronic file.

3. The information identification device according to claim 2, being further configured to, in the processing of judging whether the produced word set can uniquely identify the electronic file:
calculate the number of the electronic files including the produced word set;
judge whether the calculated number of the electronic files is one;
determine the produced word set as an identifier capable of uniquely identifying the electronic file in a case where the calculated number of the electronic files is one;
judge whether a subset of the words extracted from the identifier and the identifier assigned to the another electronic file coincide with each other; and
update the identifier assigned to the another electronic file by adding a word included in text data of the another electronic file in a case where the subset of the extracted words included in the identifier and the identifier assigned to the another electronic file coincide with each other.

4. The information identification device according to claim 2, being further configured to extract two or more identifiers each of which includes at least one word, and which is capable of uniquely identifying the electronic file.

5. The information identification device according to claim 1, being further configured to:
search a plurality of electronic files for an identifier of an electronic file coincident with the determined identifier by using the determined identifier as a search key; and
output the searched identifier and the identifier used as the search key by associating with each other.

6. An information identification system, comprising:
an information identification device for assigning a first identifier to an electronic file based on data stored in the electronic file; and
a management server, wherein:
the information identification device comprises: an interface coupled to a network; a processor coupled to the interface; and a memory coupled to the processor;
the information identification device is configured to:
calculate a frequency of appearance of a word in text data included in the electronic file;
determine the first identifier which includes at least one word, and which is capable of uniquely identifying the electronic file based on the calculated frequency of appearance; and
assign the determined first identifier to the electronic file; and
the management server is configured to store the first identifier assigned to the electronic file.

7. The information identification system according to claim 6, further comprising a mail server, wherein:
the information identification device is further configured to:
extract a word from an electronic file included in an electronic mail which is requested for send; and
transmit the extracted word to the management server;
the management server is further configured to:
compare the word received and the stored first identifier; and
transmit a result of comparison to the mail server; and
the mail server does not send the electronic mail in a case where the extracted word and the stored first identifier coincide with each other.

8. The information identification system according to claim 7, wherein the mail server is further configured notify not to send the electronic mail to a requester of sending the electronic mail in the case of preventing to send the electronic mail.

9. The information identification system according to claim 6, wherein a second identifier which is capable of uniquely identifying the electronic file in the information identification system is assigned to the electronic file.
